(19) United States
(12) Patent Application Publication
(10) Pub. No.: US 2006/0152007 A1
(43) Pub. Date: Jul. 13, 2006

(54) Generator system

(76) Inventor: Jorge L. Ortiz, San Lorenzo, PR (US)

Correspondence Address: Jorge L. Ortiz, Ciudad Masso Calle 5 A1-18, San Lorenzo, PR, 00754, US

(21) Appl. No.: 11/033,121

(22) Filed: Jan. 12, 2005

(51) Int. Cl. H02K 7/18; F03G 7/08; F02B 63/04

(52) U.S. Cl. 290/1 R

(57) ABSTRACT

A generator system includes a DC battery, an inverter, AC motor and a generator. The generator is use to transmit power to an alternating current source, such as an entire house, a refrigerator, a TV, etc. In order to run the generator, a DC battery is connected to an AC motor to supply energy so that the motor can run the generator. An inverter is introduced between the DC battery and the AC motor to change direct current to alternate current. The DC battery is charged in different ways, such as using part of the power generated by the generator or a battery charger or a 12VDC generator.

### BACKGROUND OF THE INVENTION

The invention relates to a generator system to supply energy to an alternating current source.

Portable electric power generators have become quite common and most of these generators are powered by liquid or gaseous fuels such as gasoline, diesel fuel, or propane. Due to excessive noise and exhaust gas emissions, power generators are often inconvenient in urban areas. In these kinds of generators are necessary to use filters or soundproof housings to reduce the noise and emissions which increase the cost of manufacturing of these generators. Another drawback of these generators are related to the time of operation which is limited by fuel and heat generated, forcing to stop the generators. Also this generator does not depend of solar energy or other natural element such as light or air or wind.

Thus, there is a need for a system to address all this problems that are stated above.

### BRIEF SUMMARY OF THE INVENTION

The present invention has been accomplished in view the foregoing disadvantages in the prior art. An object of the present invention is to provide a new power supply which works without fuels.

Another object of the invention is to reduce excessive noise produced by the combustion of fuel.

Another object of the invention is to limit the use of natural element such as solar energy, light or air or wind.

Still another object of the present invention is to eliminate the contamination of the ambient.

Another object of the invention is to increase the time of operation of the system.

In order to attain the above objects, the present invention provides a DC battery, an AC motor and a generator. The generator is driven by the AC motor which is powered by the DC battery. An inverter is introduced between the DC battery and the AC motor to change direct current to alternate current. The DC battery is charged in different ways, like using part of the power generated by the generator or a battery charger or a 12VDC generator.

Since the invention does not use fuel, the reduction of noise and the elimination of contaminant are achieved. Also, the generator system is to silence that there is no needs of using soundproof housing which increase the cost of manufacturing. Another advantage is that it is capable of running 24 hours a day and 7 days a week which increase the time of operation. The generator system has different utilities such as power a TV, a refrigerator and an entire house with all appliances. Also, the generator system can be use in places where conventional generators are not permitted, such as hospitals, residential buildings or libraries.

### BRIEF DESCRIPTION OF THE DRAWINGS

FIG. 1 is a schematic diagram of a generator system according to an embodiment of the invention.

FIG. 2 is a schematic diagram of a generator system according to another embodiment of the invention showing the 12VDC generator.

FIG. 3 is a schematic diagram of a generator system according to another embodiment of the invention showing the connection of relays, the battery charger, the inverter and the timer.

In order that the object of the invention may be more readily understood, it is described below.

### DESCRIPTION OF THE PREFERRED EMBODIMENTS

First in order to simplify the description, the terms battery, inverter, battery charger and electrical motor are used to imply one or more.

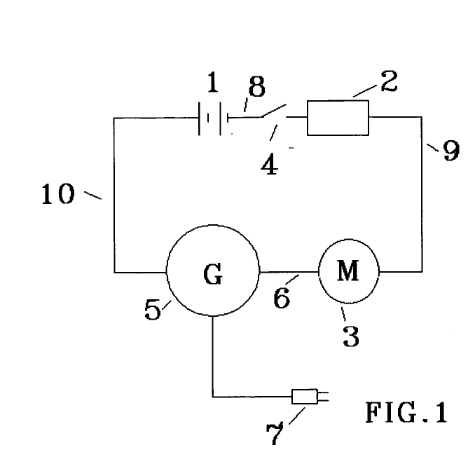

Referring to FIG. 1 comprises a DC battery 1 having a voltage of 12VDC or more for providing the input to run an AC motor 3. In order to operate the AC motor 3, an inverter 2 is between the DC battery 1 and AC motor 3 and all connected by wires 8 and 9 for changing the direct current to an alternate current. The AC motor 3 is use to transmit energy to a generator 5 by a mechanical device 6. The mechanical device can be a belt, a chain or gears, but not limited only to these devices. The generator 5 includes an output wire 7 for conducting an electrical power produced by the generator 5. Also, the generator 5 provides an output connection device 10 for transmitting a DC current in order to charge the DC battery. The generator generates enough energy to charge the DC battery and to supply current to an alternating current source, such as a house, a refrigerator, a TV or an air conditioner. Also the generator is capable of running 24 hours a day.

The generator system operates by connecting the alternating current source to the output wire 7, and opening the circuit via a switch 4 connected to the DC battery 1 through a wire 8. The AC current is transmitted by the generator 5 to the alternating current source and at the same time the DC current is transmitted to the battery to compensate for the voltage drop in order to recharge the battery.

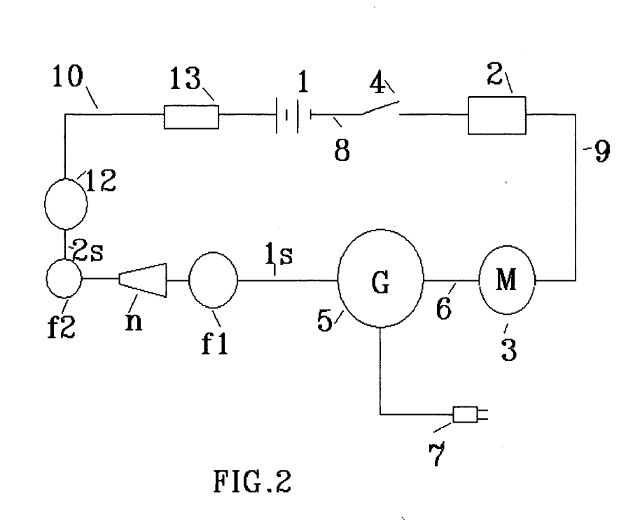

FIG. 2 shows a generator system of second embodiment of the present invention. This embodiment differs from the first embodiment in that the generator 5 includes a first shaft 1s and a first fan f1 connected to one end of the first shaft, which creates airflow. A nozzle n is used to increase the velocity of the air. This airflow is used to move or drive a 12VDC generator. The airflow is directed to a second fan f2 connected to one end of a second shaft 2s located in the 12VDC generator for the purpose of generating DC current. The 12VDC generator is used to charge the DC battery 1. Also, a regulator 13 is included for regulating the DC current from the 12VDC generator necessary for charging the DC battery.

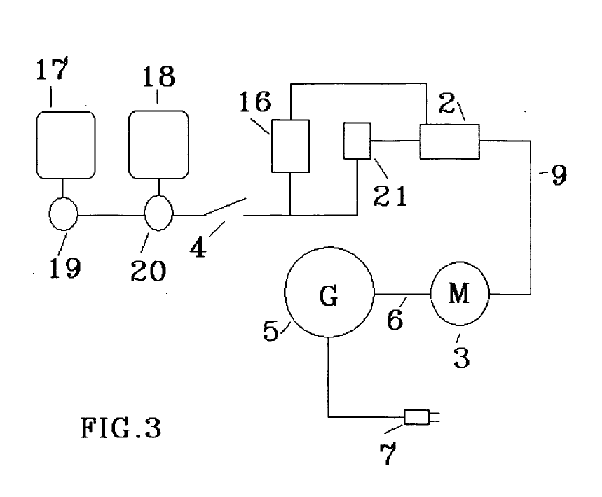

FIG. 3 shows a generator system of fourth embodiment of the present invention. This embodiment differs from the others that a battery charger 16 is connected to a battery station 17 and a battery station 18 via a relay 19 and relay 20. A control unit 21 is used to control which battery station is going to be charged by the battery charger. This control unit could be a timer or delay or transfer switch. At the same time the other battery station is going to run the AC motor 3. To charge the battery station 17, the control unit 21 is close; activate the relays 19 and 20 connecting the battery charger 16 to the battery station 17. In order to charge the other battery station 18, the control unit 21 is open; deactivate the relays 19 and 20 connecting the battery charger 16 to the battery station 18. After the battery station 17 or battery station 18 is charged the battery charger is connected using the inverter, to the other battery station that is supplying power to the AC motor 3 in order to charge the battery charger. Also this configuration is capable of running 24 hours a day by using more than one battery in each battery station connected in parallel so that the system can run one battery station when the other battery station is charging.

The various preferred embodiments described above are merely descriptive of the present invention and are no way intended to limit the scope of the invention. Modifications of the present invention will become obvious to those skilled in the art in light of the specification, and such modifications are intended to fall within the scope the appended claims.

What is claimed is:

1. A generator system comprising:
a battery to transmit power to an electrical motor;
an inverter located between said battery and said motor to change direct current to alternate current;
a generator coupled to said motor to provide power to a device;
means to transmit power from said motor to said generator; and
means to charge said battery.

2. A generator system as claimed in claim 1, wherein said battery having at least one battery.

3. A generator system as claimed in claim 1, wherein said battery having one or more batteries.

4. A generator system as claimed in claim 1, wherein said battery having two or more batteries.

5. A generator system as claimed in claim 1, wherein said electrical motor having two or more electrical motor.

6. A generator system as claimed in claim 1, wherein said inverter having two or more inverters.

7. A generator system as claimed in claim 3 or 4, wherein said batteries are in serial.

8. A generator system as claimed in claim 3 or 4, wherein said batteries are in parallel.

9. A generator system as claimed in claim 1, wherein said means to transmit power to said generator is a belt.

10. A generator system as claimed in claim 1, wherein said means to transmit power to said generator is a chain.

11. A generator system as claimed in claim 1, wherein said means to transmit power to said generator is a shaft.

12. A generator system as claimed in claim 9, wherein said shaft further comprising: one or more shafts.

13. A generator system as claimed in claim 1, wherein said means to transmit power to said generator is a combination of gears.

14. A generator system as claimed in claim 7, wherein said generator further comprising: a first pulley.

15. A generator system as claimed in claim 10, wherein said generator further comprising: a second pulley.

16. A generator system as claimed in claim 11, wherein said belt is connected to said first pulley and said second pulley.

17. A generator system as claimed in claim 1, wherein said motor further comprising: an on/off switch.

18. A generator system as claimed in claim 1, wherein said motor further comprising: a transfer switch to activate said system when a drop of current is determined in said device.

19. A generator system as claimed in claim 1, wherein said motor further comprising: a transfer switch to activate said system said motor when no current is determined in said device.

20. A generator system as claimed in claim 1, wherein said means to charge said battery is said generator.

21. A generator system as claimed in claim 18, wherein said generator is capable of power said device and charge said battery at the same time.

22. A generator system as claimed in claim 1, wherein said means to charge said battery is a 12VDC generator.

23. A generator system as claimed in claim 20, wherein said 12VDC generator comprising: a regulator to regulate the current to charge said battery.

24. A generator system as claimed in claim 21, wherein said generator comprises an internal fan which blow air to move a fan of said 12VDC generator in order to run said 12VDC generator.

25. A generator system as claimed in claim 1, wherein said means to charge said battery is a battery charger.

26. A generator system as claimed in claim 23, wherein said battery charger comprising: a control unit to regulate the current to charge said battery.

27. A generator system comprising:
battery means to transmit power to an electrical motor;
an inverter located between said battery station and said motor to change direct current to alternate current;
a generator coupled to said motor to provide power to a device;
means to transmit power from said motor to said generator; and
means to charge said battery station.

28. A generator system as claimed in claim 27, wherein said battery means comprising: a first battery station and a second battery station.

29. A generator system as claimed in claim 27, wherein said means to charge said first battery station and said second battery station comprising: a battery charger, a control unit, a first relay and a second relay.

30. A generator system as claimed in claim 29, wherein said control unit is close, activate said first and second relays connecting said battery charger to said first battery station.

31. A generator system as claimed in claim 29, wherein said control unit is open, deactivate said first and second relays connecting said battery charger to said second battery station.

32. A generator system as claimed in claim 27, wherein said first battery station having one or more batteries.

33. A generator system as claimed in claim 27, wherein said second battery station having one or more batteries.

34. A generator system comprising:
a battery to transmit power to an electrical motor;
an inverter located between said battery and said motor to change direct current to alternate current;
a generator coupled to said motor to provide power to a device;
means to transmit power from said motor to said generator; and
said generator includes an output connection device to charge said battery.

35. A generator system comprising:
a battery to transmit power to an electrical motor;
an inverter located between said battery and said motor to change direct current to alternate current;
a generator coupled to said motor to provide power to a device;
means to transmit power from said motor to said generator; and
a 12VDC generator coupled to charge said battery.

36. A generator system as claimed in claim 33, wherein said generator comprising: a first shaft and a first fan connected to one end of said first shaft.

37. A generator system as claimed in claim 34, wherein said 12VDC generator comprising: a second shaft and a second fan connected to one end of said second shaft.

38. A generator system as claimed in claim 35, wherein said first fan blow air to move said second fan in order to run said 12VDC generator.

39. A generator system as claimed in claim 1, wherein said battery charger having two or more battery chargers.

40. A generator system as claimed in claim 27, wherein said means to charge said battery is a battery charger.

41. A generator system as claimed in claim 40, wherein said battery charger having two or more battery chargers.

42. A generator system as claimed in claim 29, wherein said control unit is a transfer switch or timer or delay.
